(19) United States
(12) Patent Application Publication
(10) Pub. No.: US 2009/0110941 A1
(43) Pub. Date: Apr. 30, 2009

(54) Genuine leather cover assembly, production method therefor, seat, furniture, and leather products using the same, and member used for producing genuine leather cover assembly

(75) Inventors: Kiyoshi Takezawa, Yokohama-shi (JP); Toshiaki Sunaga, Yokohama-shi (JP)

Correspondence Address: OLIFF & BERRIDGE, PLC, P.O. BOX 320850, ALEXANDRIA, VA, 22320-4850, US

(73) Assignee: NHK SPRING CO., LTD., YOKOHAMA-SHI (JP)

(21) Appl. No.: 12/285,612

(22) Filed: Oct. 9, 2008

(30) Foreign Application Priority Data
Oct. 25, 2007 (JP) 2007-277702

(51) Int. Cl. B32B 9/02; B32B 37/00; B32B 37/04

(52) U.S. Cl. 428/473; 156/60; 156/309.9

(57) ABSTRACT

A production method for a natural leather covering assembly includes a step for contacting a surface of a natural leather with a temporary affixing sheet and a step for temporarily affixing the natural leather to the temporary affixing sheet so as to obtain a temporary affixed sheet. The production method also includes a step for bonding a wadding sheet to a surface at which the natural leather is temporarily affixed to the temporary affixed sheet.

### BACKGROUND OF THE INVENTION

1. Technical Field

The present invention relates to a production method for a natural leather covering assembly in which a natural leather is bonded to a wadding sheet, and the present invention also relates to the natural leather covering assembly, seat, furniture, and leather products using the same, and a member used for producing the natural leather covering assembly.

2. Background Art

In applying a natural leather covering assembly to vehicle seats and to furniture, a laminated material formed by affixing a natural leather to a member called a wadding sheet, such as one of polyurethane, may be used. This laminated material is produced by cutting a half-cut material of natural leather into a predetermined shape and by affixing it to the wadding sheet. The natural leather may be affixed to the wadding sheet by bonding with an adhesive agent, by sewing, or by melting the surface of the wadding sheet by heat and bonding the natural leather thereto.

On the other hand, the case of a synthetic leather, such as a leather cloth, is different from the case of a natural leather, and the synthetic leather may be formed to be wide and long. Therefore, the synthetic leather may be rolled, and the synthetic leather may be bonded to a wadding sheet while being drawn out of the roll and may then be cut out, whereby a covering assembly using a leather cloth is obtained. For such a technique, for example, a frame laminating method is disclosed in Japanese Patent Application Laid-Open No. 9-78467.

In producing a natural leather covering assembly by the above-described method, there may be the following drawbacks. First, since the half-cut material of natural leather is not easily rolled as in the case of the synthetic leather cloth, the half-cut material may be cut into a predetermined shape and be then affixed to a wadding sheet. Therefore, the ratio of manual steps is increased compared to a production of a covering assembly using a synthetic leather cloth, whereby the productivity is inferior, and the production cost is high.

In the method for bonding a natural leather and a wadding sheet by an adhesive agent, the quality (texture, suppleness, and the like) of the leather may be deteriorated by the penetration of the adhesive agent into the natural leather and by solvent in the adhesive agent. In the method for affixing a natural leather to a wadding sheet by sewing, circumferential portions of the natural leather are sewn, whereby the vicinity of the center portion of the natural leather tends to come off from the wadding, and wrinkles and slack are easily produced.

In the frame laminating method in which the surface of a wadding sheet is melted by heat and a natural leather is affixed thereto, the quality of the natural leather is not deteriorated, and wrinkles and slack may not be formed because the entire surface of the natural leather is bonded to the wadding sheet. In this case, the operation for bonding the natural leather, which has been cut into a predetermined shape, to the wadding sheet, in which the surface is heated and the vicinity of the surface is melted, is not easily automated, and manual steps are necessary, whereby the productivity and the production cost are inferior.

### SUMMARY OF THE INVENTION

An object of the present invention is to provide a technique for reducing the production cost required in a production process for affixing a natural leather to a wadding sheet. Another object of the present invention is to provide a technique to avoid deterioration of the quality of a natural leather and avoid formation of wrinkles and slack in the natural leather covering assembly affixed to a wadding sheet.

According to a first aspect of the present invention, the present invention provides a production method for a natural leather covering assembly; the method includes a step for contacting a surface of a natural leather with a temporary affixing sheet and a step for temporarily affixing the natural leather to the temporary affixing sheet so as to obtain a temporary affixed sheet. The production method also includes a step for bonding a wadding sheet to a surface on which the natural leather is temporarily affixed to the temporary affixed sheet.

In the present description, the natural lather is made of the skin or the hide of animals. The temporary affixing sheet is made of a thin film member having flexibility, to which a natural leather is temporarily affixed. The wadding sheet is a kind of base sheet or backing sheet that is bonded to a back side of a covering assembly of a natural leather and is made of a thin film member having flexibility. As the wadding sheet, a material having flexibility, such as urethane, which is formed into a sheet shape, may be used. A material in which a natural leather and a wadding sheet (or wadding) are bonded together is described as a natural leather covering assembly (or natural leather covering material).

According to the first aspect of the present invention, by using the temporary affixing sheet, the natural leather is together with the temporary affixed sheet that is easily bonded to a wadding sheet, and the wadding sheet is bonded to the temporary affixed sheet. Thus, a step for bonding a wadding sheet and a natural leather is performed with high efficiency, whereby high productivity and low production cost can be obtained. For example, by performing an automated step instead of a manual step, the natural leather is affixed to the wadding sheet.

For example, a natural lather before the leather is cut into a shape of a product, such as a natural leather called a half-cut leather that is a half-cut of a full size of a hide, may be temporarily affixed to a temporary affixing sheet so as to obtain a temporary affixed sheet. In this case, a step for bonding the natural leather to the wadding sheet, and a step for cutting the natural leather into a shape of product, can be performed with high efficiency. For example, by performing an automated step instead of a manual step, a natural leather is affixed to a wadding sheet, and a natural leather covering assembly cut into a shape of a final product is obtained.

The natural leather may be affixed to the temporary affixing sheet by using an adhesive tape, a stapler, other affixing member, or an adhesive agent. The temporary affixing is performed so as to avoid using portions of the natural leather, which will be used in a final product. Thus, since the natural leather is temporary affixed to the temporary affixing sheet by using portions that will not be used in the final product, an adhesive agent may be used. Since the natural leather should only be affixed to the temporary affixing sheet until the natural leather is bonded to the wadding, it is not necessary to perform the temporary affixing with permanent affixing strength.

According to a second aspect of the present invention, in the first aspect of the present invention, the production method further includes a step for rolling the temporary affixed sheet after the step for obtaining the temporary affixed sheet, and the temporary affixed sheet and the wadding sheet are bonded while the temporary affixed sheet is drawn out from the rolled temporary affixed sheet.

According to the second aspect of the present invention, the temporary affixed sheet, in which the natural leather is temporarily affixed to the temporary affixing sheet, is rolled, whereby the productivity of the step for bonding the temporary affixing sheet and the wadding sheet is increased. Specifically, a temporary affixed sheet may be formed by temporarily affixing plural primarily cut materials of natural leather (for example, half-cut leathers) to a temporary affixing sheet, and the temporary affixed sheet may be rolled and then be mounted to an apparatus for bonding the temporary affixed sheet and a wadding sheet. In this case, a step for bonding a wadding sheet to the back side of the natural leather that has been primarily cut is continuously performed with respect to plural primarily cut materials of natural leather.

According to a third aspect of the present invention, in the first aspect of the present invention, the wadding sheet has a surface for facing the temporary affixed sheet, and the step of bonding includes a phase of melting a surface of the wadding sheet and includes a phase for bonding the melted surface of the wadding sheet and the temporary affixed sheet. According to the third aspect of the present invention, a wadding sheet is bonded to the back surface of the primarily cut material of the natural leather, which is temporarily affixed to the temporary affixing sheet, by a frame laminating method. In these phases, the surface of the wadding sheet is melted by heat, and then the wadding sheet is bonded to the back surface of the natural leather by using a solidification phenomenon from the melted state.

In this bonding method, since the entire surface of the natural leather is bonded to the wadding sheet, the natural leather does not come off from the wadding sheet, and formation of wrinkles and slack of the natural leather is avoided. The back surface of the natural leather is rough and adheres tightly to the melted surface of the wadding sheet, whereby the natural leather and the wadding sheet are securely bonded. Moreover, by using the solidification phenomenon from the melted state of the wadding sheet, the wadding sheet is physically adhered to the rough surface of the back surface of the natural leather. Therefore, solvent does not penetrate into the natural leather, whereby decrease in the quality of the natural leather, which may occur when an adhesive agent is used, does not occur. In this case, the melted state is a state in which the surface of the wadding sheet is melted by heat and has fluidity, and the melted state also includes a semi-melted state.

According to a fourth aspect of the present invention, in the third aspect of the present invention, the temporary affixing sheet is made of a material that prevents materials of the melted surface of the wadding sheet from penetrating therethrough. According to the fourth aspect of the present invention, when the temporary affixed sheet is bonded to a wadding sheet by frame laminating, components of the melted wadding sheet do not penetrate through the temporary affixed sheet and do not emerge at the surface of the temporary affixed sheet. If the components of the wadding sheet in melted state emerge at the surface (the surface opposite to the bonded surface) of the temporary affixed sheet, when a laminated material formed by bonding the wadding sheet to the temporary affixed sheet is rolled or is stacked, the laminated materials are bonded by solidification of the components of the melted wadding sheet. According to the fourth aspect of the present invention, this phenomenon can be avoided.

The temporary affixing sheet is desirably made of a material having a certain degree of heat resistance. This is because the temporary affixing sheet may be deteriorated or be melted by heat occurring during the step of frame laminating if the heat resistance of the material is low. Therefore, the temporary affixing sheet is desirably made of a material that resists the temperature for melting the wadding sheet.

According to a fifth aspect of the present invention, in the third aspect of the present invention, the temporary affixing sheet is made of a nonwoven fabric or a paper. According to the fifth aspect of the present invention, a temporary affixing sheet, through which the components of the melted wadding sheet do not penetrate, is obtained. As a material that prevents the components of the melted wadding sheet from emerging at the surface of the temporary affixing sheet, papers, finely-woven fabrics such as twilled ground fabrics, and heat resistant resin sheets may be used.

According to a sixth aspect of the present invention, the present invention provides a natural leather covering assembly produced by the production method recited in the first aspect of the present invention. The natural leather covering assembly using the sixth aspect of the present invention may be used as a covering assembly (a member for covering surfaces) for various seats such as vehicle seats, furniture, interior decorations, bags, shoes, clothing, other daily necessities, and the like. According to the sixth aspect of the present invention, a natural leather covering assembly having a natural leather in which the quality is not deteriorated and the surface does not have wrinkles and slack, is provided at lower cost.

According to a seventh aspect of the present invention, the present invention provides a seat using the natural leather covering assembly recited in the sixth aspect of the present invention. As a seat, seats used in automobiles, airplanes, and trains, and seats of furniture such as chairs and sofas, may be mentioned. According to the seventh aspect of the present invention, a seat using a natural leather covering assembly is provided at lower cost, and the natural leather is not deteriorated in quality and does not have wrinkles and slack at the surface thereof.

According to an eighth aspect of the present invention, the present invention provides furniture using the natural leather covering assembly recited in the sixth aspect of the present invention. According to the eighth aspect of the present invention, sofas and chairs using a natural leather covering assembly is provided at lower cost, and the natural leather is not deteriorated in quality and does not have wrinkles and slack at the surface thereof.

According to a ninth aspect of the present invention, the present invention provides a leather product using the natural leather covering assembly recited in the sixth aspect of the present invention. Bags, money bags, shoes, clothing, and daily necessities may be mentioned as the leather products.

According to a tenth aspect of the present invention, the present invention provides a member for producing a natural leather covering assembly, and the member is used in a step for bonding a wadding sheet to a back surface of a natural leather. The member includes a natural leather and a temporary affixing sheet to which the natural leather is temporarily affixed in a condition in which the surface of the natural leather is contacted thereto. According to the tenth aspect of the present invention, a temporary affixed sheet that can be used in the present invention is provided.

According to the first and the second aspects of the present invention, a production method for a natural leather covering assembly, which can reduce the production cost, is provided.

According to the third aspect of the present invention, besides the above effect, a method for producing a natural leather covering assembly, without deteriorating the quality of the natural leather and without producing wrinkles and slack at the surface, is obtained.

According to the fourth and the fifth aspects of the present invention, a production method for a natural leather covering assembly is obtained, and the natural leather covering assembly can be rolled without causing bonding between rolled layers of the natural covering assembly after the natural leather is bonded to a wadding sheet.

According to the sixth aspect of the present invention, a natural leather covering assembly having advantages of the invention recited in the first aspect of the present invention is provided. According to the seventh aspect of the present invention, a seat using a natural leather covering assembly having advantages of the invention recited in the first aspect of the present invention is provided. According to the eighth aspect of the present invention, furniture using a natural leather covering assembly having advantages of the invention recited in the first aspect of the present invention is provided. According to the ninth aspect of the present invention, a leather product using a natural leather covering assembly having advantages of the invention recited in the first aspect of the present invention is provided.

According to the tenth aspect of the present invention, a member for producing a natural leather covering assembly is provided, whereby handling of the natural leather is easy, and the production cost and the physical distribution cost can be decreased.

### BRIEF DESCRIPTION OF THE DRAWINGS

FIG. 1 schematically shows a condition in which a natural leather is temporarily affixed to a temporary affixing sheet.

FIG. 2 is a schematic structure of a bonding apparatus for bonding a temporary affixed sheet and a wadding sheet.

FIGS. 3A and 3B show examples of conditions in which a part of a laminated material is drawn out from the rolled laminated material, and FIGS. 3C and 3D show schematic structures of cut materials.

FIG. 4 schematically shows an example of a vehicle seat.

FIG. 5 schematically shows another example of a vehicle seat.

FIG. 6 schematically shows an example of a case in which a natural leather covering assembly using the present invention is used in a sofa.

FIG. 7 schematically shows an example of a bag using the present invention.

### PREFERRED EMBODIMENTS OF THE INVENTION

### (1) First Embodiment

### Example of Production Method

First, an example of a production method for a natural leather covering assembly using the present invention is described. In this case, a cowhide was used as a natural leather, a nonwoven fabric (ELTAS (registered trade name) produced by Asahi Kasei Fibers Corporation) of synthetic long fibers that were bonded by thermal compression bonding was used as a temporary affixing sheet, and a porous foamed polyurethane sheet approximately 5 mm thick was used as a wadding sheet. An example that uses a frame laminating method as a bonding method will be described.

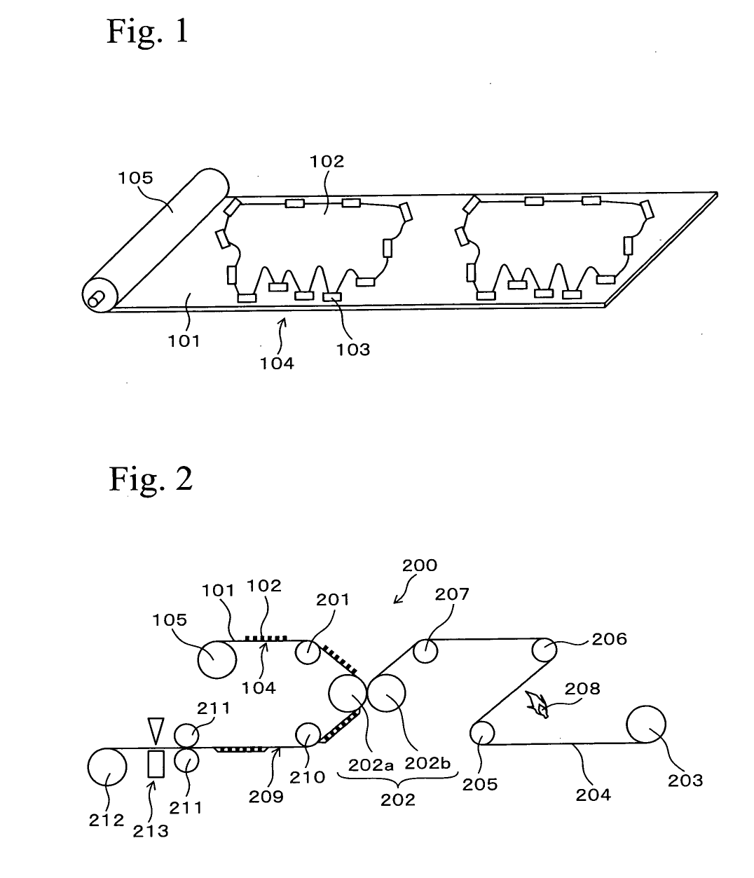

FIG. 1 schematically shows condition in which a natural leather is bonded to a temporary affixing sheet. FIG. 1 shows a condition in which a natural leather 102 that has been primarily cut is temporarily affixed as a half-cut material, on a temporary affixing sheet 101 by adhesive tapes 103. The natural leather 102 is temporarily affixed so that the back surface thereof contacts the temporary affixing sheet 101 in order to expose the back surface. FIG. 1 shows a condition in which two natural leathers are temporarily affixed on the temporary affixing sheet 101 side by side, but the number of the natural leathers can be freely selected.

The temporary affixing sheet 101 on which the natural leather 102 is temporarily affixed is referred to as a temporary affixed sheet 104. The temporary affixed sheet 104 is an example of a member for producing a natural leather covering assembly. As shown in FIG. 1, the temporary affixed sheet 104 is rolled as shown by the reference numeral 105. That is, the natural leather 102 is temporarily affixed on the temporary affixing sheet 101 so as to obtain a temporary affixed sheet 104, and then the temporary affixed sheet 104 is rolled as shown by the reference numeral 105.

FIG. 2 shows a bonding apparatus for bonding a temporary affixed sheet and a wadding sheet. FIG. 2 shows a bonding apparatus 200 to which a temporary affixed sheet 105 that is rolled is mounted. The reference numeral 201 indicates a guide roller for drawing out the temporary affixed sheet 104, and the temporary affixed sheet 104 can be drawn out from the temporary affixed sheet 105, which is rolled, to the right in the figure via the guide roller 201. FIG. 2 shows a natural leather 102 that is temporarily affixed on the temporary affixing sheet 101 upside down.

The temporary affixed sheet 104 drawn out from the rolled temporary affixed sheet 105 is conveyed to a pressure bonding device 202 via the guide roller 201. On the other hand, the wadding sheet 204, which is long, is rolled so as to be a roll 203, and the wadding sheet 204 drawn out therefrom is conveyed to the pressure bonding device 202 via guide rollers 205, 206, and 207.

A burner 208 is arranged between the guide rollers 205 and 206, whereby the surface of the wadding sheet 204 can be heated by a flame while the wadding sheet 204 is conveyed. The surface to be heated is set so as to face the natural leather 102 on the temporary affixed sheet 104 at the pressure bonding device 202.

The pressure bonding device 202 includes pressure rollers 202a and 202b formed so as to have the wadding sheet 204 and the temporary affixed sheet 104 therebetween, whereby the wadding sheet 204 and the temporary affixed sheet 104 are pressed in a condition in which they are laminated together.

In this case, the surface of the wadding sheet 204, which faces the temporary affixed sheet 204, has been heated by the burner 208, and the surface has a melted state (or is in a softened state). The surface of the wadding sheet 204 in the melted state is contacted with the exposed surface of the natural leather 102 while pressure is applied by the pressure bonding device 202, whereby the wadding sheet 204 is bonded to the back surface of the natural leather 102. Since the exposed surface of the natural leather 102 is the back surface of natural leather and is rough, the natural leather 102 and the wadding sheet 204 are securely bonded. On the other hand, the surface of the wadding sheet 204 in the melted state contacts the temporary affixing sheet 101 at portions without the natural leather 102. Therefore, the wadding sheet 204 is bonded to the portions at which the natural leather 102 of the temporary affixed sheet 104 is not arranged. This bonding method is called a frame laminating method.

Thus, the natural leather 102 is interposed between the temporary affixing sheet 101 and the wadding sheet 204, whereby a laminated material 209 is obtained, and the natural leather 102 is temporarily affixed on the temporary affixing sheet 101 and is bonded and affixed on the wadding sheet 204. The laminated material 209 is conveyed by guide rollers 210 and 211 and is rolled so as to be a roll 212. The bonding apparatus 200 includes a cutting device 213, and the laminated material 209 may be cut at appropriate timing.

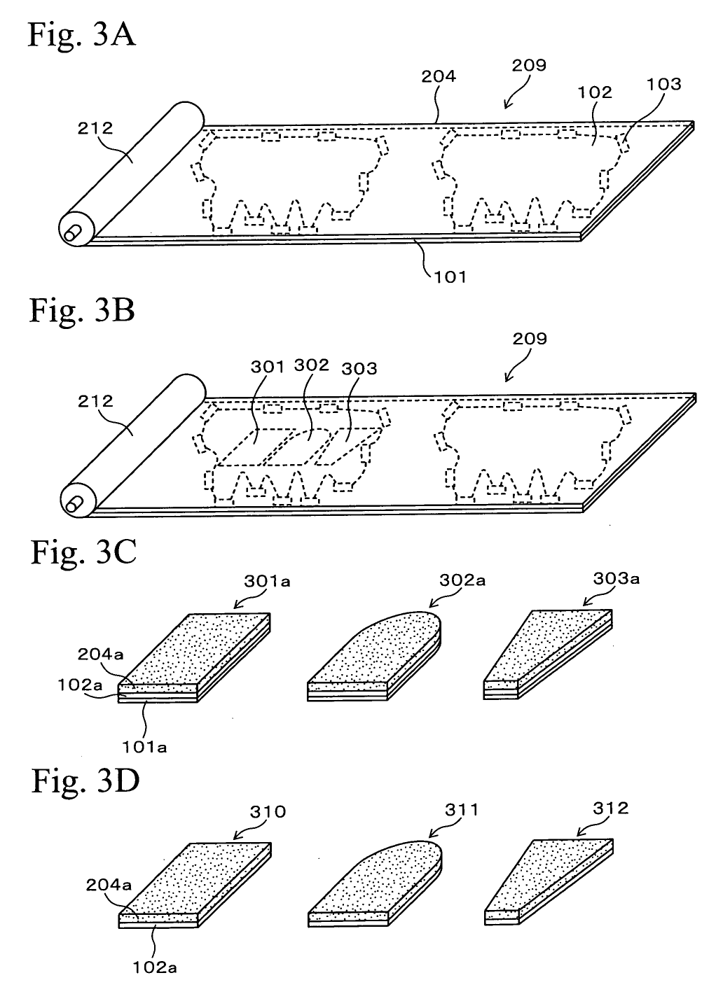

FIGS. 3A and 3B show examples of conditions in which a part of the laminated material 209 is drawn out, and FIGS. 3C and 3D show schematic structures of cut materials obtained by cutting the laminated material 209. FIG. 3A shows the laminated material 209 in which the natural leather 102 is interposed between the temporary affixing sheet 101 and the wadding sheet 204. In this case, the natural leather 102 is temporarily affixed on the temporary affixing sheet 101 by adhesive tapes 103. The natural leather 102 is bonded to the wadding sheet 204 by the above-described frame laminating method.

FIG. 3B shows designs (patterns) having predetermined shapes 301, 302, and 303. These predetermined shapes are freely selected, and required shapes may be selected. The positions of these predetermined shapes on the laminated material 209 are selected avoiding portions that temporarily affix the natural leather 102. The predetermined shapes 301 to 303 are punched and cut out from the laminated material 209 by a punching and cutting machine (not shown in the figures). The roll 212 may be mounted to the cutting machine, and the punching and cutting may be continuously performed while drawing out the laminated material 209. The cutting may not be performed only by punching and cutting out, and publicly known cutting methods may be used.

FIG. 3C schematically shows cut materials 301a, 302a, and 303a that are cut out and come off from the laminated material 209. FIG. 3C shows conditions of the cut materials 301a, 302a, and 303a immediately after cutting. Immediately after cutting, a temporary affixing sheet, a natural leather, and a wadding sheet are laminated in the order from the bottom of FIG. 3C. When the cut material 301a is described as an example, a temporary affixing sheet 101a, a natural leather 102a, and a wadding sheet 204a are laminated in the cut material 301a immediately after cutting.

The natural leather 102a is temporarily affixed to the temporary affixing sheet 101a by the adhesive tapes 103 as shown in FIG. 3A, and the predetermined shapes 301, 302, and 303 of cutting patterns are positioned avoiding the portions at which the adhesive tapes 103 temporarily affix the natural leather 102a to the temporary affixing sheet 101a. Therefore, in a case of the cut material 301a, the natural leather 102a is not affixed to the temporary affixing sheet 101a and therefore easily comes off. In a natural leather covering assembly used for seats and sofas, a margin to seam is generally formed, and the adhesive tape may remain at this margin. Therefore, a portion for a margin to seam may be used as a portion for temporarily affixing the natural leather by adhesive tape.

FIG. 3D schematically shows conditions in which a temporary affixing sheet is separated from each of cut materials. That is, FIG. 3D schematically shows conditions in which the temporary affixing sheet is separated from each of the cut materials, and natural leathers are bonded to wadding sheets. In this case, a natural leather covering assembly 310 shown in FIG. 3D is obtained by separating the temporary affixing sheet 101a from the cut material 301a shown in FIG. 3C. The natural leather covering assembly 310 has a laminated structure in which the natural leather 102a is bonded to the wadding sheet 204a. FIG. 3D shows natural leather covering assemblies 311 and 312 having the same laminated structure as that of the natural leather covering assembly 310.

Thus, natural leather covering assemblies 310 to 312 formed so as to have a predetermined shape are obtained. Each of the natural leather covering assemblies 310 to 312 may be used for seats and sofas so that the surface of the natural leather (for example, as indicated by reference numeral 102a) is on the outside surface of the seat or sofa. The natural leather covering assemblies 310 to 312 may be obtained by cutting the laminated material 209 after the temporary affixing sheet 101 is peeled off from the laminated material 209.

### Advantages

As shown in FIG. 1, in the present embodiment, the natural leather 102 of a half-cut material is temporarily affixed to the temporary affixing sheet 101 by the adhesive tapes 103, whereby a temporary affixed sheet 104 is formed. Thus, the primarily cut material of natural leather (in this example, the half-cut material indicated by the reference numeral 102), which cannot be made so as to have a long length as a processing material, is formed so as to have a shape with long length and therefore can be continuously processed as shown in FIG. 2. Accordingly, productivities of bonding and subsequent cutting step are increased, whereby the production cost is reduced.

Since the wadding sheet 204 is affixed to the natural leather 102 without using an adhesive agent, decrease in the quality of the natural leather can be prevented. By using a nonwoven fabric, through which the components of the melted wadding sheet 204 do not easily penetrate, as the temporary affixing sheet 101, the laminated material 209 can be rolled as shown by the reference numeral 212 without resulting in bonding between rolled layers of the laminated material 209.

By using a frame laminating method, the natural leather 102 and the wadding sheet 204 are bonded at the entire surfaces thereof that contact each other. Therefore, a laminated structure, in which wrinkles and slack are not easily formed when the natural leather covering assembly is attached to a curved surface or is bent, is obtained.

The temporary affixed sheet 104 may be rolled as shown by the reference numeral 105. The rolled temporary affixed sheet 104 is easily handled during storage and transportation, whereby high workability is obtained. Moreover, the rolled temporary affixed sheet 104 has an advantage in efficiently using spaces required during storage and transportation. Therefore, for example, when the step shown in FIG. 1 and the step shown in FIG. 2 are performed at different places or at intervals, the storage cost and the physical distribution cost can be reduced.

### (2) Second Embodiment

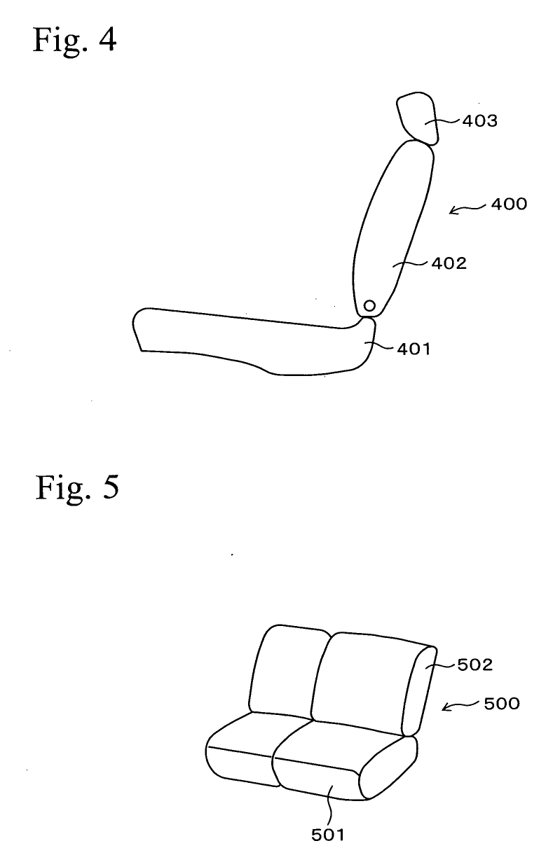

Examples of various seats using the natural leather covering assembly, in which an example of the production method therefor is shown in the first embodiment, are described. FIG. 4 shows a vehicle seat 400 that may be used for a driver seat or a front passenger seat of an automobile. The vehicle seat 400 includes a seat cushion 401 for receiving the weight of the body of a person who is seated, a seat back 402 used as a backrest, and a headrest 403 for the seat. The surfaces of the seat cushion 401, the seat back 402, and the headrest 403 for the seat are covered with the natural leather covering assemblies exemplified in the first embodiment.

FIG. 5 shows another example of a vehicle seat and shows a vehicle seat 500. The vehicle seat 500 may be used for a back passenger seat (rear seat) and includes a rear seat cushion 501 and a rear seat back 502. The surfaces of the rear seat cushion 501 and the seat back 502 are covered with the natural leather covering assemblies exemplified in the first embodiment.

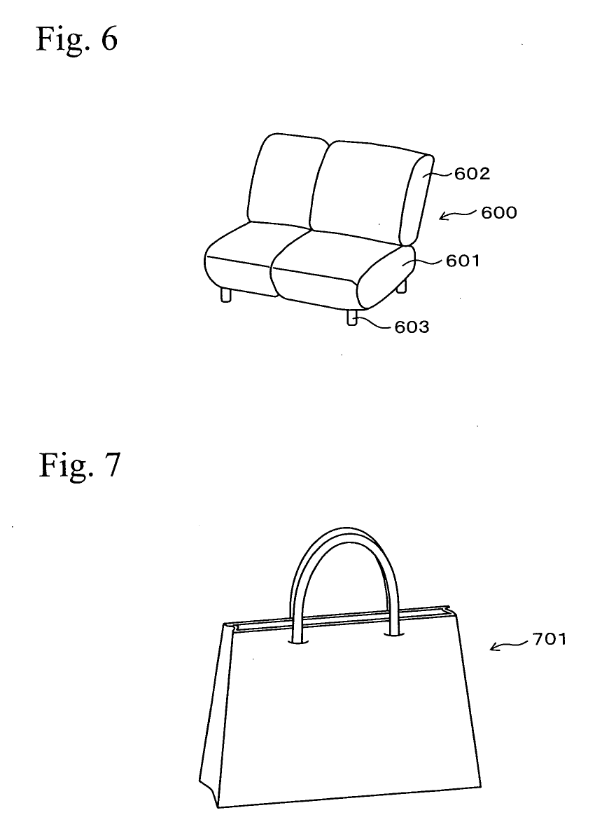

Examples of vehicle seats are shown in FIGS. 4 and 5, and the seat structure similar to those of the vehicle seats may be used for seats of airplanes, vessels, trains, and the like. The natural leather covering assembly using the present invention may be used for furniture. FIG. 6 schematically shows an example of a case in which a natural leather covering assembly using the present invention is used in a sofa.

FIG. 6 shows a sofa 600, and the sofa 600 includes a seat cushion 601 and a seat back 602. The surfaces of the seat cushion 601 and the seat back 602 are covered with the natural leather covering assemblies exemplified in the first embodiment. The reference numeral 603 indicates foot portions for supporting the sofa.

### (3) Third Embodiment

The natural leather covering assembly using the present invention may be used for various leather products such as clothing, bags, and money bags in addition to seats and sofas. FIG. 7 schematically shows an example of a bag using the present invention and shows a bag 701 of which the surface is covered with the natural leather covering assembly using the present invention.

### (4) Fourth Embodiment

In the step shown in FIG. 3A, instead of the natural leather 102 of the half-cut material, a natural leather that has been cut into a predetermined shape, such as a shape shown by the reference numerals 301 to 303 in FIG. 3B, may be used. In this case, a natural leather is cut into a predetermined shape, such as a shape shown by the reference numerals 301 to 303 of the cutting pattern in FIG. 3B, and then the natural leather is temporarily affixed to the temporary affixing sheet 101. Thus, a temporary affixed sheet (corresponding to the reference numeral 104 in FIG. 1), in which a natural leather cut into a final shape of a product is temporarily affixed to the temporary affixing sheet 101, is obtained.

When this embodiment is used, since a step shown in FIG. 2 can be used, the step for bonding the temporary affixed sheet and the wadding sheet is simplified, and high productivity and low production cost are provided. However, in this embodiment, the natural leather must be secondly cut into a final shape of a product before the step for cutting the temporary affixed sheet shown in FIG. 3B, whereby the productivity and the production cost in the cutting step are inferior to those in the case of the first embodiment.

### (5) Fifth Embodiment

As a temporary affixing sheet, a paper or a finely woven fabric may be used. Fastening devices or adhesive agents may be used instead of adhesive tapes. Since the temporarily affixing portions of the natural leather are not used in the final product, the adhesive agents may be used.

The wadding sheet 204 and the temporary affixed sheet 104 may be bonded not by frame laminating method but by using an adhesive agent. In this case, in order to reduce the negative influence on the quality of the natural leather 102, the kind of the adhesive agent is limited, and the quality of the natural leather will be inferior compared to that in a case of using the frame laminating method. The viscosity and the amount of the adhesive agent required for securely bonding, and the viscosity and the amount of the adhesive agent required for bonding so as to reduce the negative influence to the natural leather 102, may not be balanced, or may not be balanced in a good condition.

As a modification of the case of using the adhesive agent, a hot-melt bonding sheet may be used. In this case, in the step shown in FIG. 2, the hot-melt bonding sheet is interposed between the temporary affixed sheet 104 and the wadding sheet 204, and pressure is applied thereto by the pressure rollers 202a and 202b while heating them, whereby the temporary affixed sheet 104 and the wadding sheet 204 are bonded.

The present invention may be used for various types of seats and leather products.

What is claimed is:

1. A production method for a natural leather covering assembly, the method comprising:
a step for contacting a surface of a natural leather with a temporary affixing sheet;
a step for temporarily affixing the natural leather to the temporary affixing sheet so as to obtain a temporary affixed sheet; and
a step for bonding a wadding sheet to a surface in which the natural leather is temporarily affixed to the temporary affixed sheet.

2. The production method for the natural leather covering assembly according to claim 1, wherein the method further comprises a step for rolling the temporary affixed sheet after the step for obtaining the temporary affixed sheet, and the temporary affixed sheet and the wadding sheet are bonded while the temporary affixed sheet is drawn out from the rolled temporary affixed sheet.

3. The production method for the natural leather covering assembly according to claim 1, wherein the wadding sheet has a surface for facing the temporary affixed sheet, and the step for bonding the wadding sheet to the temporary affixed sheet comprises:
a phase of melting the surface of the wadding sheet; and
a phase of bonding the melted surface of the wadding sheet and the temporary affixed sheet.

4. The production method for the natural leather covering assembly according to claim 3, wherein the temporary affixing sheet is made of a material that prevents melted materials of the wadding sheet form penetrating therethrough.

5. The production method for the natural leather covering assembly according to claim 3, wherein the temporary affixing sheet is made of a nonwoven fabric or a paper.

6. A natural leather covering assembly produced by the production method recited in claim 1.

7. A seat using the natural leather covering assembly recited in claim 6.

8. A piece of furniture using the natural leather covering assembly recited in claim 6.

9. A leather product using the natural leather covering assembly recited in claim 6.

10. A member for producing a natural leather covering assembly, the member being used in a step for bonding a wadding sheet to a back surface of a natural leather and comprising:
a natural leather; and
a temporary affixing sheet to which the natural leather is temporarily affixed in a condition in which the surface of the natural leather is contacted thereto.
